(19) United States
(12) Patent Application Publication
(10) Pub. No.: US 2002/0129268 A1
(43) Pub. Date: Sep. 12, 2002

(54) Information processor, personal authentication method, and computer-readable recording medium on which a program for executing the method by computer is recorded

(76) Inventors: Takashi Ito, Chiba-shi (JP); Hiroshi Odagiri, Chiba-shi (JP); Toshiya Kanesaka, Chiba-shi (JP); Haruo Hashimoto, Chiba-shi (JP); Masahiro Noguchi, Chiba-shi (JP)

Correspondence Address: ADAMS & WILKS, 31st Floor, 50 Broadway, New York, NY, 10004, US

(21) Appl. No.: 09/803,866

(22) Filed: Mar. 12, 2001

(51) Int. Cl. H04L 9/32

(52) U.S. Cl. 713/200

(57) ABSTRACT

An information processor and a personal authentication method arranged to easily and securely perform authentication using living-body information on a person whose identification is to be authenticated. The information processor has an input section for inputting living-body information (fingerprint pattern) representing a unique feature of a person whose identification is to be authenticated, a collation section for collating the input living-body information with living-body information registered in a collation data storage section in advance, and a transmission section for transmitting authentication data to an external unit on the basis of the result of the collation.

### BACKGROUND OF THE INVENTION

1. Field of the Invention

The present invention relates to an information processor capable of personal authentication using living-body information on a person whose identification is to be authenticated, a method for such personal authentication, and a computer-readable recording medium on which a program for executing the method by a computer is recorded.

2. Description of the Related Art

Conventionally, a personal authentication method comprising requiring a person to input a password is ordinarily used. However, since a password is difficult to remember and can be stolen, there is a demand for authentication methods other than password-authentication methods. An authentication method using personal living-body information has been proposed as one of non-password methods. This method uses a fingerprint or a voiceprint representing features of an individual as living-body information and is, therefore, free from all problems relating to the need for memorizing a password (and, hence, the problem of a password being forgotten) and the risk of a password being stolen. Therefore, this method is regarded as one of authentication methods improved in security.

However, an authentication method using such living-body information requires setting a living-body information authentication sensor in each of places where authentication is necessary, and also requires registering collation information for authentication (fingerprint information, voiceprint information or the like for collation) in advance. Also, a person who operates a device for authentication (a person whose identification is to be authenticated) must perform an authentication operation (e.g., bringing a fingertip into contact with a designated portion of a sensor, or uttering a voice). Thus, the authentication method uses a troublesome operating process.

### SUMMARY OF THE INVENTION

In view of the above-described problems of the conventional art, an object of the present invention is to provide an information processor capable of performing easier and safer authentication using living-body information on a person whose identification is to be authenticated, a method for such personal authentication, and a computer-readable recording medium on which a program for executing the method by a computer is recorded.

To achieve the above-described object, according to one aspect of the present invention, there is provided an information processor comprising a living-body information input circuit for inputting living-body information representing a unique feature of a person whose identification is to be authenticated, a collation circuit for collating living-body information input by the living-body information input circuit with living-body information registered in advance, and a transmission circuit for transmitting authentication data to an external unit on the basis of a result of collation performed by the collation circuit.

According to the present invention, there is no need to provide an input circuit for inputting living-body information and a collation circuit for performing collation of living-body information in each of a plurality of external units.

The information processor according to the present invention further comprises a collation date information storage circuit for storing information on a date at which collation is performed by the collation circuit, and the transmission circuit transmits to the external unit the latest item in the date information stored in the collation date information storage circuit together with the authentication data.

According to the present invention, it is possible to prevent authentication data alone from being abused in authentication without collation of living-body information.

Also, the information processor in accordance with the present invention is a device which can be worn about an wrist.

According to the present invention, the information processor can be always carried readily and the authentication operation of the information processor can be performed with the same feeling as the wrist watch operation.

According to another aspect of the present invention, there is provided a personal authentication method comprising a living-body information input step of inputting living-body information representing a unique feature of a person whose identification is to be authenticated, a collation step of collating living-body information input in the living-body information input step with living-body information registered in advance, a transmitting step of transmitting authentication data on the basis of a result of collation in the collation step, a receiving step of receiving the authentication data transmitted in the transmitting step, and an authentication step of performing authentication of the person whose identification is to be authenticated on the basis of the authentication data received in the receiving step.

According to the present invention, living-body information input processing and processing for collation of input living-body information can be separated from authentication processing, and these kinds of processing can be performed by separate devices.

According to still another aspect of the present invention, there is provided a personal authentication method comprising a living-body information input step of inputting living-body information representing a unique feature of a person whose identification is to be authenticated, a collation step of collating living-body information input in the living-body information input step with living-body information registered in advance, date obtaining step of obtaining information on the date of collation in the collation step, a transmitting step of transmitting authentication data and the date information obtained in the date obtaining step on the basis of a result of collation in the collation step, a receiving step of receiving the authentication data and the date information transmitted in the transmitting step, and an authentication step of performing authentication of the person whose identification is to be authenticated on the basis of the authentication data received in the receiving step only when the date information received in the receiving step is the latest information.

According to the present invention, it is possible to prevent authentication data alone from being abused in authentication without collation of living-body information.

According to a further aspect of the present invention, there is provided a computer-readable recording medium comprising a program recorded thereon, the program enabling a computer to execute one of the above-described methods.

According to the present invention, a program for executing the above-described method by a computer is recorded so as to be machine-readable, thus realizing the above-described method by circuit of a computer.

### BRIEF DESCRIPTION OF THE DRAWINGS

FIG. 1 is a diagram showing the configuration of a personal authentication system including an information processor in an embodiment of the present invention;

FIG. 2 is a block diagram showing the hardware configuration of the information processor in the embodiment of the present invention;

FIG. 3 is a block diagrams showing the configuration of the information processor and an external unit in the embodiment of the present invention with respect to functions;

FIG. 4 is a flowchart showing the procedure of processing in the information processor in the embodiment of the present invention; and

FIG. 5 is a flowchart showing the procedure of processing in the external unit in the embodiment of the present invention.

### DESCRIPTION OF THE PREFERRED EMBODIMENT

An information processor, a personal authentication method and a computer-readable recording medium on which a program for executing the method by a computer is recorded will be described as a preferred embodiment of the present invention with reference to the accompanying drawings.

(Configuration of Information Processor)

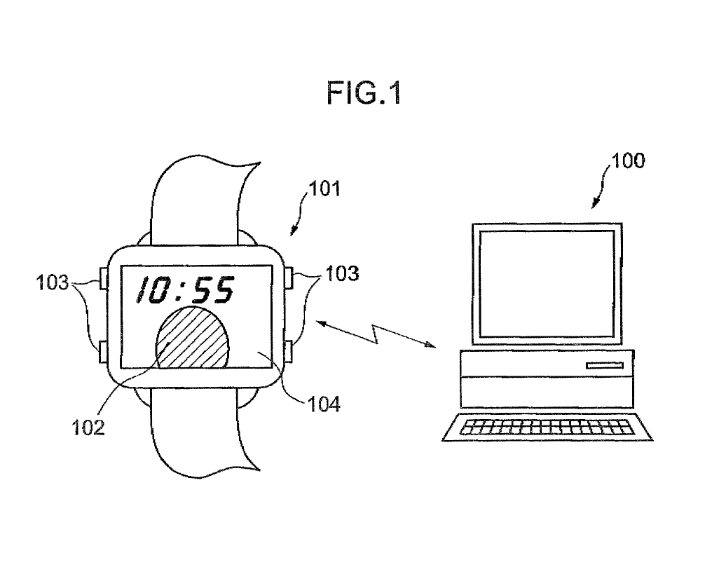

FIG. 1 is a diagram showing the configuration of an example of a personal authentication system including an information processor in this embodiment. The system shown in FIG. 1 is constituted by an external unit (personal computer) 100 and an information processor (wrist watch type of information processor) 101.

The external unit 100 may be any of systems requiring authentication before use, for example, a personal computer, a portable telephone, a personal data assistant (FDA), a lock mechanism and system for opening and closing a door, a personal safe, a briefcase, a pocketbook, etc., a mechanism and system for on/off control of main power source of various electrical systems, a system for controlling a household electrical appliance, or a lock mechanism and system for opening and closing a door, a trunk, or a fuel tank cap of automobile.

The information processor (wrist watch type of information processor) 101 performs short-distance wireless communication with the external unit 100. In this embodiment, the information processor 101 is a wrist watch type of information processor. Ordinarily, a possessor (user) having the information processor 101 in his or her possession always wears the information processor 101 about the wrist. It is possible for the possessor (user) wearing the information processor 101 to recognize whether the distance between the possessor (user) and the external unit 100 is within such a range that short-distance communication between the information processor 101 and the external unit 100 is possible.

The information processor 101 is not limited to the wrist watch type of information processor and may be of any type as long as it can be always carried by the possessor (user) who carries the first type of the information processor. For example, it may be of a pendant type or a type attached to a garment.

A technique used for short-distance wireless communication between the external unit 100 and the information processor (wrist watch type of information processor) 101 is, for example, “Bluetooth” with specifications: a frequency of 2.45 GHz, a connection-distance coverage of about 10 m, and a transfer rate of 1 Mbps. Through a port based on “Bluetooth”, any of various devices, e.g., portable telephones, a portable personal computers, peripheral devices can be connected. A personal computer or the like can be set non-operable when its communication by “Bluetooth” is cut off, and the engine of a vehicle (a motor vehicle, a motorbike) or the like can be automatically stopped by cutting off of a “Bluetooth” communication.

The information processor 101 has a fingerprint detecting sensor 102. The user can input fingerprint pattern data by bringing the inner surface (fingerprint portion) of the last joint of his or her finger into contact with a surface of the fingerprint detecting sensor 102. For example, to detect a fingerprint through the fingerprint detecting sensor 102, (1) a capacitance detection method of detecting grooves and ridges forming a fingerprint as changes in capacitance, (2) an optical detection method of recognizing a pattern by receiving light with a charge-coupled device (CCD) and obtaining a light correlation with a spatial light modulator, (3) a thermal detection method of detecting fingerprint grooves and ridges as changes in temperature, or (4) a resistance detection method of detecting fingerprint grooves and ridges by measuring the resistance between electrodes.

The information processor 101 has various switches (buttons) 103 for operations relating to information processing, and a display 104 for displaying data such as characters, images, and function information as well as date information (a time, a date, a day of the week, etc.).

(Configuration of Information Processor)

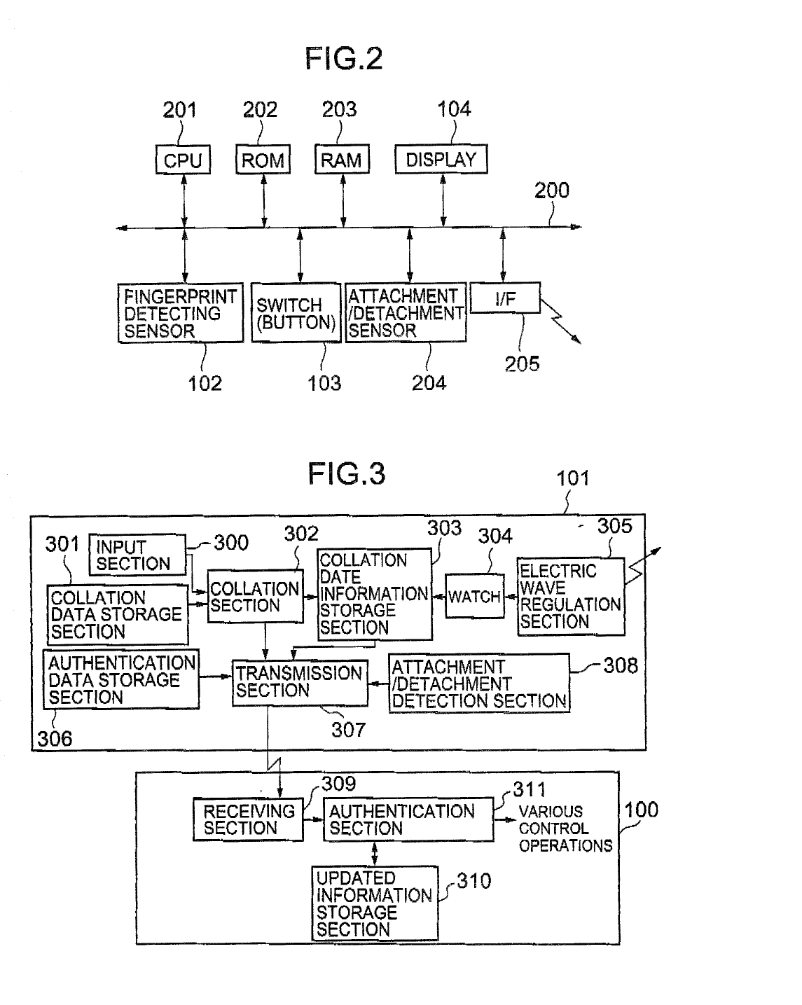

The hardware configuration of the information processor (wrist watch type of information processor) 101 in this embodiment will next be described with reference to the block diagram of FIG. 2.

Referring to FIG. 2, the information processor (wrist watch type of information processor) 101 is constituted by a central processing unit (CPU) 201 for overall control of the system, a read-only memory (ROM) 202 on which a boot program or the like is stored, a random access memory (RAM) 203 used as a work area for the CPU 201, an attachment/detachment sensor 204 described below, an interface (I/F) 205 for interfacing with the external unit 100, and a bus 200 which connects the above-described components to each other.

(Functional Configuration of the Information Processor and External Unit)

The configuration of functional sections of the information processor 101 and external unit in this embodiment will be described with reference to the block diagram of FIG. 3.

Referring to FIG. 3, the information processor (wrist watch type of information processor) 101 has an input section 300, a collation data storage section 301, a collation section 302, a collation date information storage section 303, a clock 304, an electric wave regulation section 305, an authentication data storage section 306, a transmission section 307, and an attachment/detachment detection section 308.

Living-body information representing a unique feature of a person whose identification is to be authenticated is input to the input section 300. Kinds of living-body information other than fingerprint data from which information to be input to the input section 300 may be selected are, for example, data on a voice print and data on a pattern in the iris of the eye. If fingerprint data is input to the input section 300, the input data undergoes code processing, processing for removing noise, processing for modification such as contour enhancement, etc. The function of the input section 300 can be realized by the fingerprint detecting sensor 102. While only the fingerprint detecting sensor 102 is shown as a sensor for inputting living-body information in the hardware shown in FIG. 2, a sensor for detecting a voice print, a pattern in the iris of the eye, or the like (e.g., a microphone in the case of detection of a voiceprint) may also be provided.

The collation data storage section 301 has collation data stored in advance. The function of the collation data storage section 301 can be realized by using a recording medium, such as RAM 203 shown in FIG. 2, and a system for controlling recording on the recording medium. The collation section 302 collates living-body information input through the input section 300 with living-body information stored (registered) in the collation data storage section 301 in advance.

The function of the collation section 302 is realized by the CPU 201 executing instruction processing according to instructions described in a program recorded on a recording medium such as ROM 202 or RAM 203. Examples of a fingerprint collation method are (1) a method which is used for capacitance detection or the like, and which is based on detection of singular points such that fingerprint pattern change points or the like are detected, and (2) a method based on light correlation detection with a spatial light modulator or the like.

The collation date information storage section 303 stores information (timestamp) on the date of collation performed by the collation section 302. Preferably, this information (timestamp) is encrypted before being stored. The function of the collation date information storage section 303 is realized by using a recording medium, such as ROM 202 or RAM 203 shown in FIG. 2, and a system for controlling recording on the recording medium. Also, the collation date information storage section 303 may be formed as a common storage section also having the function of the authentication data storage section 306. In such a case, a timestamp may be stored as a portion of authentication data after being encrypted.

A time designating a collation date can be obtained from the clock 304. Further, the electric wave regulation section 305 using, for example, the Japan Standard time wave sent from a JJY (a call sign of a wireless station) enables more accurate determination of a time designating a collation date. Each time collation processing is performed, only a timestamp or authentication data including a timestamp is updated.

The authentication data storage section 306 stores data used for authentication by the external unit 100. The function of the authentication data storage section 306 can be realized by using a recording medium, such as ROM 202 or RAM 203 shown, in FIG. 2, and a system for controlling recording on the recording medium. The transmission section 307 transmits authentication data to the external unit 100 on the basis of the result of collation performed by the collation section 302, and also transmits to the external unit 100 the latest item in collation date information stored in the collation date information storage section 303.

The transmission section 307 may use a high-security digital communication system, e.g., a spread-spectrum system or the like. Also, data to be transmitted by the transmission section 307 may be encrypted. The function of the transmission section 307 can be realized by the I/F 205 shown in FIG. 2.

The attachment/detachment detection section 308 detects detachment of the wrist watch type of information processor 101 from the wrist. The function of the attachment/detachment detection section 308 is realized by the attachment/detachment sensor 204. The attachment/detachment sensor 204 is, for example, (1) a temperature sensor (for sensing., for example, body heat to detect a change in temperature at the time of attachment or detachment), (2) a pressure sensor (for sensing, for example, a pressure relating to closeness of contact with the wrist to detect a change in closeness of contact at the time of attachment or detachment), (3) a pulse sensor (for sensing, for example, the existence/nonexistence of a pulse at the time of attachment or detachment), and (4) an optical sensor (for sensing, for example, shielding of light at the time of wearing).

When detachment of the write watch type of information processor 101 from the wrist is detected with the attachment/detachment sensor 204, information on the occurrence of detachment is transmitted form the transmission section 307 to the external unit 101 to make a below-described authentication procedure invalid, thereby ensuring security of the external unit 101 even if the wrist watch type of information processor 101 is stolen, for example.

The external unit 100 comprises a receiving section 309, an updated information storage section 310, and an authentication section 311. The receiving section 309 receives the latest items in authentication data and collation date information transmitted from the information processor 101, and decodes the received data. The function of the receiving section 309 can be realized by the same hardware as the I/F 205 shown in FIG. 2.

The updated information storage section 310 stores collation date information received by the receiving section 309, and holds, as updated information, the received collation date information together with authentication data authenticated most lately. The function of the updated information storage section 310 is realized by using a recording medium, such as a RAM or a hard disk and a system for controlling of the recording medium (both not shown).

The authentication section 311 compares the updated information stored in the updated information storage section 310 with collation date information received by the receiving section 309, and makes a determination as to whether the received collation date information is the latest data, in other words, the received collation date information designates a date later than the date in the stored updated information. If the received collation date information is the latest data, the authentication section 311 performs authentication processing of the received authentication data. If the result of authentication processing is OK (the data is recognized as authentic), the operator (person whose identification has been authenticated) can perform various control operations which the operator is allowed to perform by authentication in the external unit 100. Then the authentication data stored in the information processor 101 is encrypted and, thereafter, it is impossible to extract only the security-protected authentication data and to abuse the data.

Details of the authentication processing will not be described. However, substantially the same processing as authentication processing ordinarily performed by using a password or the like in personal computers can be used as the authentication processing in accordance with the present invention. The function of the authentication section 311 can be realized by a CPU or the like executing instruction processing according to instructions described in a program (e.g., data base software) recorded on a recording medium, such as a ROM, a RAM, a hard disk or a floppy disk.

(Procedure of Processing of Information Processor)

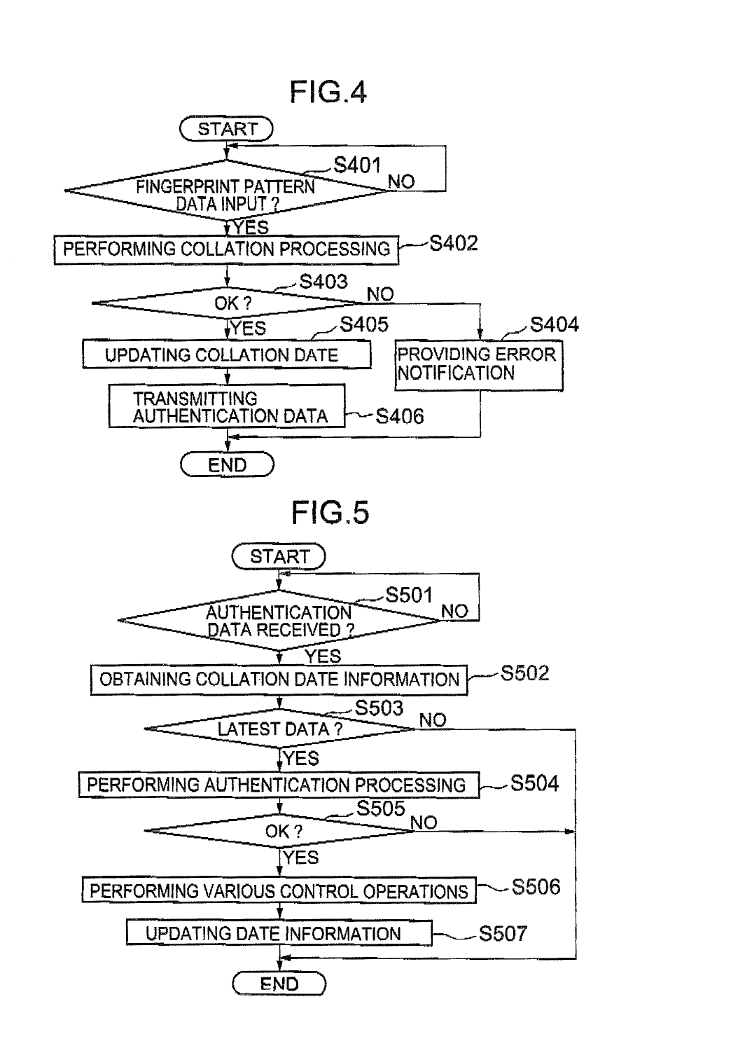

The contents of collation processing performed by the information processor 101 will next be described. FIG. 4 is a flowchart of the procedure of processing performed by the information processor in this embodiment. Referring to FIG. 4, a determination is first made as to whether fingerprint pattern data has been input (step S401). when, after waiting for input of fingerprint pattern data, fingerprint pattern data is input (if Yes in step S401), collation processing is performed by comparing the input fingerprint pattern data with data stored in the collation data storage section 301 (step S402).

If the result of the collation is not OK (if No in step S403), error notification is provided (step S404) and the sequence of steps is terminated. If the result of the collation is OK in step S403 (if Yes in step S403), collation date information stored in the collation date information storage section 303 is updated (step S405), and the authentication data stored in the authentication data storage section 306 as well as the updated collation date information are transmitted to the external unit (step S406).

(Procedure of Processing in External Unit)

The contents of authentication processing performed by the external unit 100 will next be described with reference to FIG. 5. A determination is first made as to whether authentication data has been received (step S501). When, after waiting for reception of authentication data, authentication data is received (if Yes in step S501), collation date information is obtained as well as the authentication data (step S502).

A determination is then made as to whether the obtained collation date information is the latest data on the basis of information stored in the updated information storage section 310 (step S503). If the obtained collation date information is not the latest data (if No in step S503), the process is terminated. On the other hand, If the obtained collation date information is the latest data (it Yes in step S503), authentication processing is performed (step S504). If the result of authentication processing is not OK (if No in step S505), the process is terminated. Thus, the external unit is accessed with data having an older timestamp, it can reject the access.

On the other hand, it the result of authentication processing is OK (if Yes in step S505), various control operations can be performed (step S506). The date information in the updated information storage section 310 is updated (step S507) and the process is terminated.

As described above, in the embodiment of the present invention are provided the input section 300 for inputting living-body information (fingerprint pattern data) representing a unique feature of a person whose identification is to be authenticated, the collation section 302 which collates the input living-body information with living-body information registered in the collation data storage section 301 in advance, and the transmission section 307 which transmits authentication data to the external unit 100 on the basis of the result of collation. Therefore, there is no need to provide the input circuit for inputting living-body information and the collation circuit for collation of living-body information in each of a plurality of external units 100. Thus, authentication using living-body information on a person whose identification is to be authenticated can be performed easily with security.

In this embodiment of the present invention, the collation date information storage section 303 which stores information on a date at which collation is performed by the collation section 302 is also provided and the transmission section 307 transmits to the external unit 100 the latest item in date information stored in the collation date information storage section 303 together with authentication data. Therefore, it is possible to prevent authentication data alone from being abused in authentication without collation of living-body information. Thus, authentication using living-body body information on a person whose identification is to be authenticated can be performed with security.

Also, in this embodiment, since the information processor 101 is designed so as to able to be worn about the wrist, it can be always carried readily and the authentication operation of the information processor 101 can be performed with the same feeling as the wrist watch operation.

As the information processor 101, devices or articles to which the present invention can be applied as well as to the wrist watch type of information processor are, for example, (1) remote controllers for household electrical appliances, (2) keys, (3) portable telephones or desk telephones, (4) accessories (bracelets, rings, necklace, pendants, key holders, etc.), (5) stationery, and (6) stamps.

The personal authentication method described above with respect to the embodiment of the present invention can be realized by executing a program prepared in accordance with the method in a computer, such as a personal computer or a workstation. This program is recorded on a computer-readable recording medium, such as a hard disk, a floppy disk, a compact disk-read only memory (CD-ROM), a magneto-optical disc (MO), or a digital versatile disk (DVD) and is executed by being read out from the recording medium. This program can be distributed through the recording medium or a transmission medium in the form of a network, such as the Internet.

According to the present invention, as described above, there are provided the living-body information input circuit for inputting living-body information representing a unique feature of a person whose identification is to be authenticated, the collation circuit for collating living-body information input by the living-body information input circuit with living-body information registered in advance, and the transmission circuit for transmitting authentication data to an external unit on the basis of a result of collation performed by the collation circuit, thereby eliminating a need to provide the input circuit for inputting living-body information and the collation circuit for performing collation of living-body information in each of a plurality of external units. Consequently, an information processor can be obtained which is capable of easily and securely performing authentication of a person whose identification is to be authenticated by using living-body information on the person.

According to the present invention, there are further provided the collation date information storage circuit for storing information on a date at which collation is performed by the collation circuit, and the transmission circuit transmits to the external unit the latest item in the date information stored in the collation date information storage circuit together with the authentication data, thereby preventing the authentication data alone from being abused in authentication without collation of living-body information. Therefore, an information processor can be obtained which is capable of easily and securely performing authentication of a person whose identification is to be authenticated by using living-body information on the person.

According to the present invention, the above-described information processor is a device capable of being worn about an wrist and can be always carried readily. Therefore, the authentication operation of the information processor can be performed with the same feeling as the wrist watch operation. Thus, it is possible to obtain an information processor which is capable of easily and securely performing authentication of a person whose identification is to be authenticated by using living-body information on the person.

The present invention also provides a personal authentication method comprising a living-body information input step of inputting living-body information representing a unique feature of a person whose identification is to be authenticated, a collation step of collating living-body information input in the living-body information input step with living-body information registered in advance, a transmitting step of transmitting authentication data on the basis of a result of collation in the collation step, a receiving step of receiving the authentication data transmitted in the transmitting step, and an authentication step of performing authentication of the person whose identification is to be authenticated on the basis of the authentication data received in the receiving step, thereby enabling, processing for inputting living-body information and for collation of input living-body information authentication processing to be separated from each other and to be performed by separate devices. Thus, it is possible to obtain a personal authentication method which makes it possible to easily and securely perform authentication of a person whose identification is to be authenticated by using living-body information on the person.

The present invention also provides a personal authentication method comprising a living-body information input step of inputting living-body information representing a unique feature of a person whose identification is to be authenticated, a collation step of collating living-body information input in the living-body information input step with living-body information registered in advance, date obtaining step of obtaining information on the date of collation in the collation step, a transmitting step of transmitting authentication data and the date information obtained in the date obtaining step on the basis of a result of collation in the collation step, a receiving step of receiving the authentication data and the date information transmitted in the transmitting step, and an authentication step of performing authentication of the person whose identification is to be authenticated on the basis of the authentication data received in the receiving step only when the date information received in the receiving step is the latest information, thereby preventing authentication data alone from being abused in authentication without collation of living-body information. Thus, it is possible to obtain a personal authentication method which makes it possible to easily and securely perform authentication of a person whose identification is to be authenticated by using living-body information on the person.

According to the present invention, a program for executing the above-described method by a computer is recorded so as to be machine-readable. Thus, it is possible to obtain a recording medium which enables one of the above-described methods to be executed by circuit of a computer.

What is claimed is:

1. An information processor comprising:
a living-body information input circuit to input living-body information representing a unique feature of a person whose identification is to be authenticated;
a collation circuit to collate living-body information input by the living-body information input circuit with living-body information registered in advance; and
a transmission circuit to transmit authentication data to an external unit on the basis of a result of collation performed by the collation circuit.

2. An information processor according to claim 1, further comprising:
a collation date information storage circuit to store information on a date at which collation is performed by the collation circuit,
wherein the transmission circuit transmits to the external unit the latest item in the date information stored in the collation date information storage circuit together with the authentication data.

3. An information processor according to claim 1, wherein the information processor is of a type capable of being worn about an wrist.

4. An information processor according to claim 2, wherein the information processor is of a type capable of being worn about an wrist.

5. A personal authentication method comprising:
a living-body information input step of inputting living-body information representing a unique feature of a person whose identification is to be authenticated;
a collation step of collating living-body information input in the living-body information input step with living-body information registered in advance;
a transmitting step of transmitting authentication data on the basis of a result of collation in the collation step;
a receiving step of receiving the authentication data transmitted in the transmitting step; and
an authentication step of performing authentication of the person whose identification is to be authenticated on the basis of the authentication data received in the receiving step.

6. A personal authentication method comprising:
a living-body information input step of inputting living-body information representing a unique feature of a person whose identification is to be authenticated;
a collation step of collating living-body information input in the living-body information input step with living-body information registered in advance;
date obtaining step of obtaining information on the date of collation in the collation step;
a transmitting step of transmitting authentication data and date information obtained in the date obtaining step on the basis of a result of collation in the collation step;
a receiving step of receiving the authentication data and the date information transmitted in the transmitting step; and
an authentication step of performing authentication of the person whose identification is to be authenticated on the basis of the authentication data received in the receiving step only when the date information received in the receiving step is the latest information.

7. A computer-readable recording medium comprising a program recorded thereon, the program for enabling a computer to execute the method according to claim 5.

8. A computer-readable recording medium comprising a program recorded thereon, the program for enabling a computer to execute the method according to claim 6.
